(19) United States
(12) Patent Application Publication
(10) Pub. No.: US 2006/0272299 A1
(43) Pub. Date: Dec. 7, 2006

(54) Cyclone dust collecting apparatus

(75) Inventor: Cheol-ho Choi, Gwangju-city (KR)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: SAMSUNG GWANGJU ELECTRONICS CO., LTD.

(21) Appl. No.: 11/317,619

(22) Filed: Dec. 23, 2005

(30) Foreign Application Priority Data
Jun. 3, 2005 (KR) 10-2005-0047762

(51) Int. Cl. B01D 50/00

(52) U.S. Cl. 55/337

(57) ABSTRACT

A cyclone dust collecting apparatus according to an embodiment of the present invention, comprises a housing centrifugally separating and collecting dust from drawn-in air and discharging cleaned air, a housing cover connected to an upper part of the housing, a discharge cover openably connected to a lower part of the housing, and a filter assembly. The housing includes an air inlet, a cyclone unit centrifugally separating dust from external air drawn in through the air inlet, an inflow guide pipe having a substantially curved shape and guiding the whole air drawn in through the air inlet to the cyclone unit, a dust collection unit formed at one side of the cyclone unit to collect the separated dust, and an air outlet where the dust-separated air is discharged.

### CROSS-REFERENCE TO RELATED APPLICATIONS

This application claims benefit under 35 U.S.C. §119(a) of Korean Patent Application No. 2005-47762, filed Jun. 3, 2005, the entire contents of which are incorporated herein by reference.

### BACKGROUND OF THE INVENTION

1. Field of the invention

The present invention relates to a vacuum cleaner. More particularly, the present invention relates to a cyclone dust collecting apparatus employed in a vacuum cleaner to separate dust from drawn-in air by a centrifugal force.

2. Description of the Related Art

General vacuum cleaners comprise a suction brush for drawing in air including dust on a surface being cleaned, a dust collecting apparatus for separating dust from the air drawn in through the suction brush, and a suction motor functioning as a driving source. A conventional vacuum cleaner used to adopt a dust bag; however, the dust bag requires frequent replacement and also has a problem in hygiene. Accordingly, a cyclone dust collecting apparatus has been prevailing nowadays because it is nearly permanent. The cyclone dust collecting apparatus generates a whirling air current from the air including dust and separates dust from the air using a centrifugal force of the whirling air current. Dust-separated air is discharged to the outside, passing through a filter and a suction motor, whereas the separated dust is collected in a dust collection-unit.

However, it is hard to separate fine dust perfectly with the general cyclone dust collecting apparatus. Furthermore, a predetermined suction force in the cyclone dust collecting apparatus needs to be uniformly maintained in order for favorable performance of dust separation; nevertheless, an air path having a bent form in the cyclone dust collecting apparatus usually causes loss of pressure, thereby considerably weakening the suction force. As for the suction force, the cyclone dust collecting apparatus is inferior to the conventional vacuum cleaner using the dust bag. However, in order to strengthen the suction force of the suction motor, power consumption increases.

As a result, research for an improved cyclone dust collecting apparatus capable of maintaining uniform suction force and reducing loss of pressure is in progress.

### SUMMARY OF THE INVENTION

An aspect of the present invention is to solve at least the above problems and/or disadvantages and to provide at least the advantages described below. Accordingly, an aspect of the present invention is to provide an improved cyclone dust collecting apparatus that is capable of enhancing dust separation efficiency, minimizing loss of pressure of drawn-in air, and maintaining a uniform suction force without abrupt decrease during a cleaning work.

In order to achieve the above-described aspects of the present invention, there is provided a cyclone dust collecting apparatus comprising a housing centrifugally separating and collecting dust from drawn-in air and discharging cleaned air, a housing cover, a discharge cover, and a filter assembly.

The housing includes an air inlet, a cyclone unit centrifugally separating dust from external air drawn in through the air inlet, a dust collection unit formed at one side of the cyclone unit to collect the separated dust, and an air outlet where the dust-separated air is discharged. The housing cover is connected to an upper part of the housing, thereby forming a dust path between the cyclone unit and the dust collection unit. The discharge cover is openably connected to a lower part of the housing. The filter assembly is removably mounted at one side of the housing to filter off fine dust included in the air discharged from the air outlet. The cyclone unit includes an inflow guide pipe having a substantially curved shape and guiding the whole air drawn in through the air inlet to the cyclone unit, and the air inlet is connected to the inflow guide pipe so that the air drawn in through the air inlet directly flows to the cyclone unit.

The cyclone unit comprises a cylindrical chamber outer wall, and a predetermined part of the inflow guide pipe is integrally formed with the chamber outer wall.

An entrance of the dust path is extended in a direction of the inflow guide pipe so as to be partly overlapped with the inflow guide pipe.

The housing further comprises a discharge guide pipe which guides the dust-separated air toward the air outlet, and an upped end the discharge guide pipe is disposed at a higher position than the dust path to prevent the separated dust from flowing into the discharge guide pipe.

The housing further comprises a noise reducing rib mounted in the discharge guide pipe to reduce noise generated by the air passing through the discharge guide pipe by contacting with the air.

The housing cover further comprises a discharge guide cap protruded at a position corresponding to the upper end of the discharge guide pipe in a hemisphere form to guide the dust-separated air toward the discharge guide pipe.

The air passed through the discharge guide pipe preferably all moves to the air outlet.

Sectional area of the air passage increases from a discharge port of the discharge guide pipe toward the air outlet.

The air outlet is equipped with an outlet mesh that is removably mounted.

The filter assembly comprises a first filter made of porous mesh, a second filter made of sponge comprising smaller pores than the first filter, and a third filter comprising smaller pores than the second filter that are mounted in the above order.

### BRIEF DESCRIPTION OF THE DRAWING FIGURES

The above aspect and other features of the present invention will become more apparent by describing in detail exemplary embodiments thereof with reference to the attached drawing figures, wherein;

FIG. 1 is a perspective view schematically showing a vacuum cleaner having a cyclone dust collecting apparatus according to an exemplary embodiment of the present invention;

FIG. 2 is a front-perspective view of the cyclone dust collecting apparatus according to an exemplary embodiment of the present invention;

FIG. 3 is an top-perspective view of the cyclone dust collecting apparatus with the housing cover of FIG. 2 removed;

FIG. 4 is a bottom-perspective view of the cyclone dust collecting apparatus with the discharge cover of FIG. 2 removed;

FIG. 5 is a rear-perspective view of the cyclone dust collecting apparatus with the filter assembly of FIG. 2 removed, to show a connection structure between an outlet mesh and an air outlet;

FIG. 6 is a rear-perspective exploded view of the cyclone dust collecting illustrating the filter assembly of FIG. 2;

FIG. 7 is a perspective view of the cyclone dust collecting apparatus with a housing of FIG. 2 partly cut away, to explain the operation of the cyclone dust collecting apparatus; and

FIG. 8 is a graph illustrating a suction force of the cyclone dust collecting apparatus according to an exemplary embodiment of the present invention.

### DETAILED DESCRIPTION OF THE EXEMPLARY EMBODIMENTS

Hereinafter, an embodiment of the present invention will be described in detail with reference to the accompanying drawing figures.

In the following description, same drawing reference numerals are used for the same elements even in different drawings. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

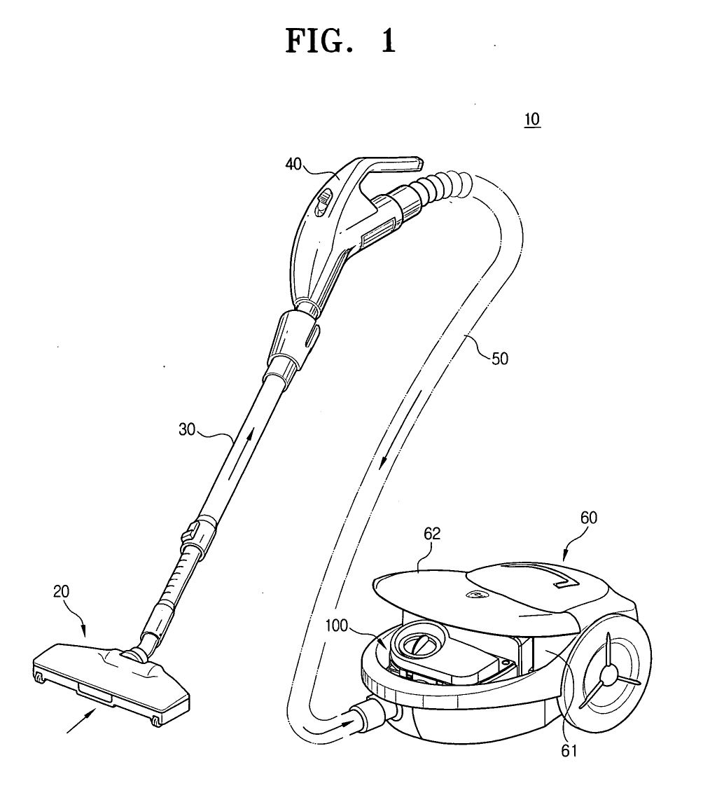

FIG. 1 is a perspective view of a canister-type vacuum cleaner adopting a cyclone dust collecting apparatus according to an exemplary embodiment of the present invention. Referring to FIG. 1, a canister-type vacuum cleaner 10 comprises a cleaner body 60, a suction brush 20 for drawing in dust from a surface being cleaned, an operation unit 40 for operation of the vacuum cleaner 10, an extension pipe 30 connecting the suction brush 20 with the operation unit 40, a flexible hose 50 connecting the operation unit 40 with the cleaner body 60, and a cyclone dust collecting apparatus 100.

The cleaner body 60 includes a motor driving chamber (not shown) where a suction motor for supplying a suction force is mounted and a dust collecting chamber 61. The cyclone dust collecting apparatus 100, which separates dust from dust-laden air using a centrifugal force, is removably mounted in the dust collecting chamber 61. Although FIG. I shows the cyclone dust collecting apparatus 100 employed in a canister-type vacuum cleaner, the cyclone dust collecting apparatus 100 may be employed in an upright-type vacuum cleaner as well.

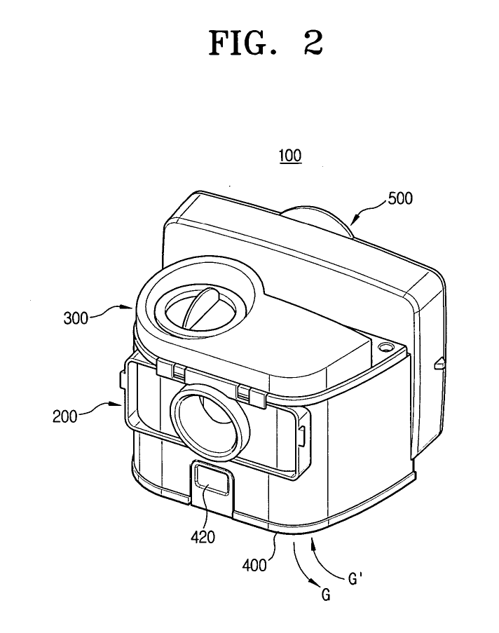

Referring to FIG. 2, the cyclone dust collecting apparatus 100 comprises a housing 200, a housing cover 300, a discharge cover 400, and a filter assembly 500.Housing 200 separates dust from drawn-in air, collects the separated dust, and discharges the air as cleaned. The housing cover 300 is connected to an upper part of the housing 200. The discharge cover 400 is openably connected to a lower part of the housing 200. The filter assembly 500 is connected to a rear part of the housing 200.

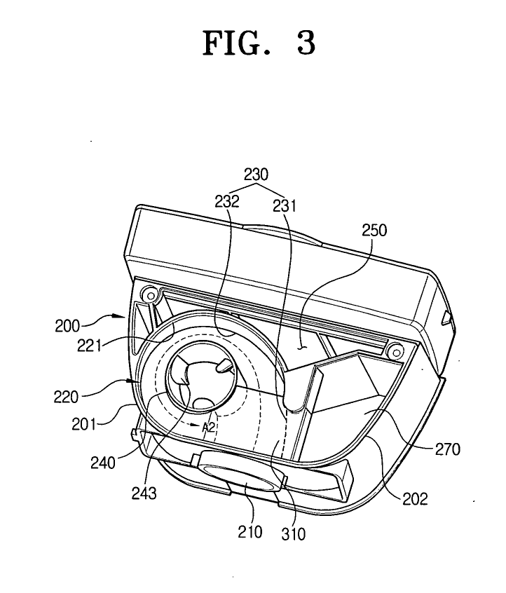

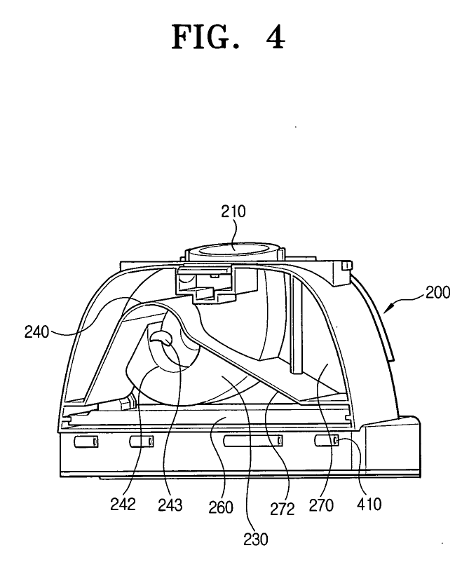

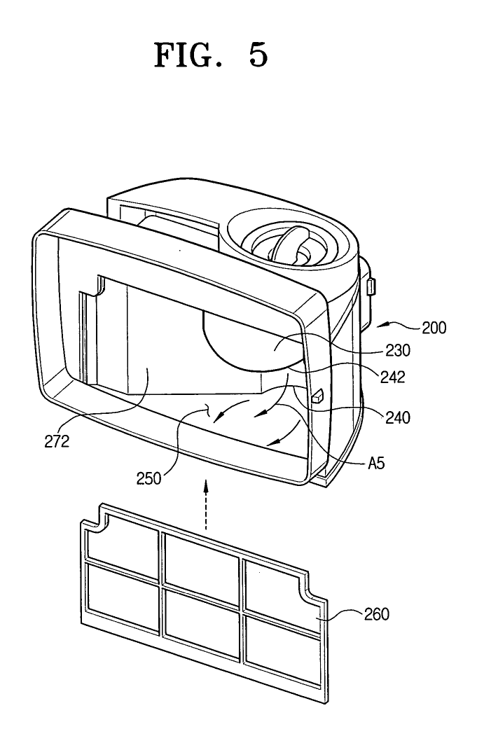

FIG. 3 is a perspective view of the cyclone dust collecting apparatus 100 with housing cover 300 removed. FIG. 4 is a perspective view of the cyclone dust collecting apparatus 100 with discharge cover 400 removed. FIG. 5 is a perspective view of the cyclone dust collecting apparatus 100 with filter assembly 500 removed, viewed from a rear side to show a connection structure between an outlet mesh and an air outlet. As shown in the drawings, the housing 200 comprises an air inlet 210, a cyclone unit 220 having an inflow guide pipe 230, an air outlet 250 and a dust collection unit 270.

The air inlet 210 is disposed on a front of the housing 200, substantially in the center with respect to width of the housing 200. The air inlet 210 may be integrally formed with the housing 200 or may be formed as a pipe protruded from the housing 200 by a predetermined length. The air inlet 210 can be placed in fluid communication with the flexible hose 50 of the vacuum cleaner 10 (FIG. 1) so as to function as an entrance for dust-laden air drawn in through the suction brush 20, the extension pipe 30, and the flexible hose 50 to flow into the cyclone dust collecting apparatus 100.

The cyclone unit 220 is mounted in the housing 200 to one side of air inlet 210. The cyclone unit 220centrifugally separates the dust from the dust-laden air that is drawn in through the air inlet 210 and the inflow guide pipe 230. A chamber outer wall 221 of the cyclone unit 220, having a cylindrical shape and being partly formed by a sidewall 201 of the housing 200, provides a space for forming a whirling air current. The drawn-in air spirally ascends toward the housing cover 300 (FIG. 2). Since being heavier than the air, the dust is moved toward the chamber outer wall 221 by a centrifugal force and then ascends, being entrained by the air current.

The inflow guide pipe 230 fluidly connects the air inlet 210 and the cyclone unit 220. As shown in the drawings, the inflow guide pipe 230 is curved almost throughout and guides the whole dust-laden air drawn in through the air inlet 210 into the cyclone unit 220. The inflow guide pipe 230 comprises a first guide part 231 connected with the air inlet 250 and a second guide part 232 connected with the chamber outer wall 221. The first and the second guide parts 231 and 232 are smoothly connected in a curved manner. Preferably, the first guide part 231 is shorter than the second guide part 232 and is curved rather than being straight, such that the air drawn in through the air inlet 210 is directly guided into the cyclone unit 220 without making a stay. That is, the air inlet 210 of the housing 200 acts as an entrance of the cyclone unit 220.

The inflow guide pipe 230 extends from the air inlet 210, spirally ascending by substantially 360°. Due to the inflow guide pipe 230, accordingly, the air drawn in through the air inlet 210 spirally ascends from the cyclone unit 220 toward the housing cover 300, as shown by an arrow A2 (FIG. 3).

Thus, by configuring the cyclone dust collecting apparatus 100 such that the dust-laden air passed through the air inlet 210 is directly guided into the cyclone unit 220 to generate the whirling air current and by configuring the inflow guide pipe 230 to be curved as much as possible, loss of pressure can be reduced while the dust-laden air passing through the air inlet 210 is drawn into the cyclone unit 220. As a result, the air drawn into the cyclone unit 220 is able to generate the whirling air current, while maintaining a uniform suction force.

A discharge guide pipe 240 is shaped as a pipe having a substantially circular section and protruded by a predetermined length from a central bottom portion of the cyclone unit 220. The dust-separated air is discharged through the discharge guide pipe 240. A lower circumferential part of the discharge guide pipe 240, in the area directed towards the air outlet 250, is half cut out, thereby forming a discharge port 242 at the cut-out portion. The discharge port 242 is disposed approximately at ⅓ height of the discharge guide pipe 240 from the bottom of the discharge guide pipe 240. The dust-separated air discharged through the discharge port 242 flows to the air outlet 250, as shown by an arrow A5 (FIG. 5).

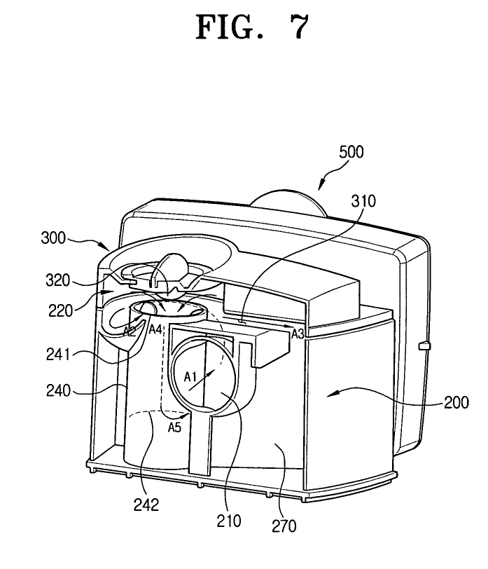

An upper end 241 of the discharge guide pipe 240 is preferably disposed higher than a dust path 310 connecting the cyclone unit 220 and the dust collection unit 270, as shown in FIG. 7. As aforementioned, the dust heavier than the air radiates toward the chamber outer wall 221 by the centrifugal force and then ascends along the air current. If, here, the upper end 241 of the discharge guide pipe 240 is formed equal to or lower than the dust path 310, the centrifugally separated dust may easily flow into the discharge guide pipe 240, being entrained by the air current. Therefore, inflow of the separated dust into the discharge guide pipe 240 can be prevented by disposing the upper end 241 of the discharge guide pipe 240 at a higher position than the dust path 310.

The discharge guide pipe 240 has therein a plurality of noise reducing ribs 243 protruded by a predetermined length from an inner wall of the discharge guide pipe 240 toward the center of the discharge guide pipe 240. The noise reducing ribs 243 restrain the dust-separated air from turning turbulent, thereby attenuating noise generated by such the turbulence.

The air outlet 250 is disposed at a rear portion of the housing 200. All of the air passed through the discharge port 242 of the discharge guide pipe 240 flows to the air outlet 250 and exits to the outside through the air outlet 250.

As shown in FIG. 5, it is preferable that an air passage from the discharge port 242 of the discharge guide pipe 240 to the air outlet 250 has an increasing section toward the air outlet 250. According to this embodiment, the air outlet 250 occupies almost all area of the rear portion of the housing 200. At the air outlet 250, an outlet mesh 260 may be mounted to filter fine dust not separated by the centrifugal force and still included in the discharged air. The outlet mesh 260 is preferably removable for convenient maintenance.

The air outlet 250 is connected with the suction motor (not shown) of the vacuum cleaner 10 (FIG. 1). Advantageously, in the cyclone dust collecting apparatus 100 of the present embodiment, because the air passed through the discharge guide pipe 240 flows diffusingly to the suction motor (not shown) through the air outlet 250, blocking of the outlet mesh 260 can be retarded, thereby preventing abrupt decrease of the suction force. In addition, turbulence is restrained by simplifying the structure of the air outlet 250, as shown in the drawings. Therefore, loss of pressure is minimized, accordingly reducing decrease of the suction force.

The dust collection unit 270 is mounted in the housing 200 to another side of air inlet 210, namely to the side of the air inlet 210 that is opposite the cyclone unit 220. The dust collection unit 270 collects the dust centrifugally separated from the air by the cyclone unit 220. The dust collection unit 270 occupies approximately half volume of the cyclone unit 220 with respect to the width. In the similar manner with the cyclone unit 220, the dust collection unit 270 is partly formed by the other sidewall 202 of the housing 200. The housing 200 has a partition 272 (FIGS. 4 and 5) for dividing the dust collection unit 270 and the air outlet 250. Although the partition 272 is integrally formed with the discharge guide pipe 240 in this embodiment for easy manufacture, the present invention is not limited so.

Referring to FIGS. 3 and 7, when the housing cover 300 is connected to the housing 200, the dust path 310 interconnecting the cyclone unit 220 and the dust collection unit 270 is formed between the housing cover 300 and the housing 200. The dust separated by the cyclone unit 220 is moved radially outward due to the centrifugal force, passed through the dust path 310, and moved to the dust collection unit 270. An entrance of the dust path 310 is mounted to direct the inflow guide pipe 230, so as to overlap with the inflow guide pipe 230 at least by a part. Preferably, the entrance of the dust path 3 10 is extended in a direction to the inflow guide pipe 230 as far as possible so as to be far apart from the dust collection unit 270. This structure directs the dust separated by the cyclone unit 220 towards the dust path 310, thereby improving dust separation efficiency.

The housing cover 300 is provided with a discharge guide cap 320 having a hemispheric form and protruded downward at a position corresponding to the discharge guide pipe 240 of the cyclone unit 220. The discharge guide cap 320 guides the air ascending from the cyclone unit 220 into the discharge guide pipe 240. Therefore, the air ascends in the cyclone unit 220 up to the housing cover 300 and the dust in the air is centrifugally separated and moved to the dust path 310. The dust-separated air is guided by the discharge guide cap 320, thereby flowing into the discharge guide pipe 240.

Referring back to FIGS.2 and 4, the discharge cover 400 is attached to a lower end of the housing 200 by a hinge shaft 410, thereby pivoting on the hinge shaft 410 in an opening and closing manner in arrowed directions G and G′. When the discharge cover 400 is opened, the common bottom of the dust collection unit 270 and the cyclone unit 220 is opened to discharge the dust collected in the dust collection unit 270 by gravity. An opening button 420 is formed at the lower part of the housing 200 to open the discharge cover 400.

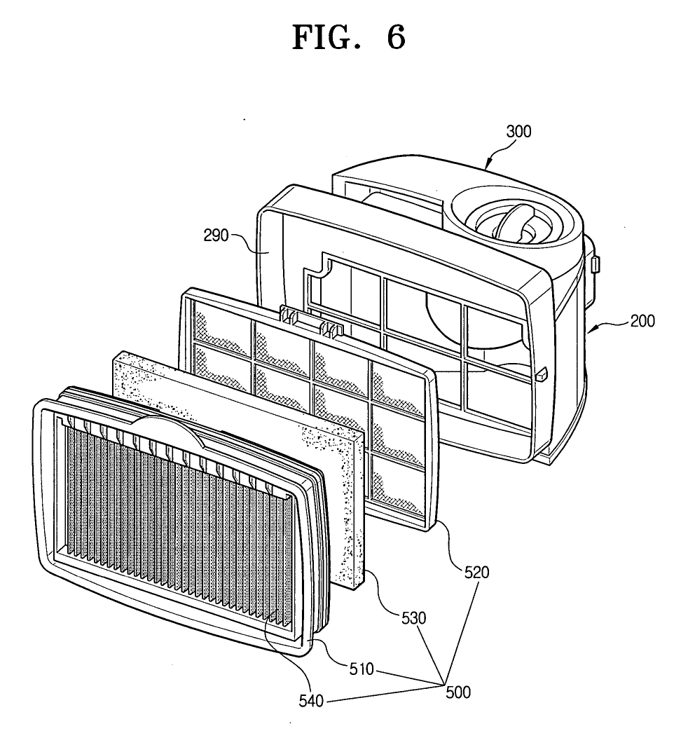

Referring to FIG. 6, the filter assembly 500 is removably mounted to a filter mounting part 290 disposed at the rear side of the housing 200. The filter assembly 500 is disposed between the air outlet 250 and the motor driving chamber (not shown) of the vacuum cleaner 10 (FIG. 1) with respect to the air passage. Therefore, the air passed through the cyclone unit 220 and the outlet mesh 260 mounted at the air outlet 250 is then discharged, passing through the filter assembly 500. The filter assembly 500 filters off the fine dust still remaining in the air that has passed through the outlet mesh 260. To this end, the filter assembly 500 can include first, second, and third filters 520, 530 and 540, respectively, each having a different size of pores and different filtering steps.

The first filter 520 is arranged at the innermost position in the filter assembly 500 to filter off relatively large dust. The first filter 520 is removably mounted to a filter assembly body 510 and made of mesh having relatively large pores. The third filter 540 is formed integrally with the filter assembly body 510 and arranged at the outermost position of the filter assembly 500. The third filter 540 is made of nonwoven fabric having relatively small pores to filter off the fine dust that is not caught by the first or second filters 520, 530. The second filter 530 is removably mounted to the filter assembly body 510 and preferably made of sponge having pores smaller than those of the first filter 520 but larger than those of the third filter 540 to filter off at least part of the dust that is not caught by the first filter 520. The filter assembly 500 having such a structure is capable of improving the dust separation efficiency.

The filter assembly 500 according to an embodiment of the present invention comprises three filters 520, 530 and 540. However, the number of the filters is adaptable. For example, the first filter 520 may be omitted or one or more other filters may be additionally provided.

Hereinbelow, the operation of the cyclone dust collecting apparatus according to an embodiment of the present invention will be described with reference to FIG. 7.

Upon driving the suction motor (not shown), the dust on the surface being cleaned is drawn in together with ambient air through the suction brush 20 (FIG. 1). The drawn-in air flows in through the air inlet 210 of the cyclone dust collecting apparatus 100 in an arrowed direction A1.

The drawn-in air flows into the cyclone unit 220 along the inflow guide pipe 230 (FIG. 3). The air guided into the cyclone unit 220 ascends from the cyclone unit 220 up to the housing cover 300 in a rotating manner, as shown by an arrow A2. During this, the dust included in the air is moved radially outward due to the centrifugal force and then collected in the dust collection unit 270, passing through the dust path 310 as shown by arrow direction A3.

The dust-separated air collides with a ceiling of the housing cover 300, flows into the discharge guide pipe 240 by the discharge guide cap 320, and descends in an arrowed direction A4. The air passed through the discharge port 242 of the discharge guide pipe 240 is discharged through the air outlet 250 (FIG. 5) where the outlet mesh 260 is mounted, in an arrowed direction A5. The air passed through the air outlet 250 is filtered by the filter assembly 500 so that the fine dust is separated, and then discharged to the outside of the cyclone dust collecting apparatus 100.

When the dust collection unit 270 is filled with the dust by a certain amount, the user can open the discharge cover 400 by pushing the opening button 420 and remove the collected dust (See FIG. 2).

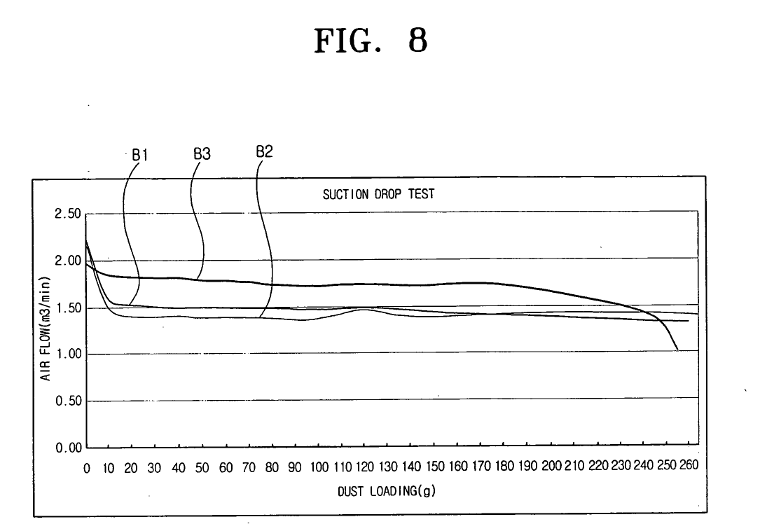

FIG. 8 is a graph experimentally obtained to show changes in suction flow of the cyclone dust collecting apparatus 100. The horizontal axis denotes quantity (grams) of the dust being collected in the dust collection unit 270, while the vertical axis denotes air flow per unit time (meters³/minute). The quantity of dust collected in the dust collection unit 270 varies according to the size of the cyclone dust collecting apparatus 100. If the air flow remains high with the same suction force, this means that the suction force is being maintained without decrease.

As shown in the graph, under the same condition of the suction force, the air flow B3 of the cyclone dust collecting apparatus 100 according to the present embodiment is higher than those B1 and B2 of other general cyclone dust collecting apparatuses. Also, in the general cyclone dust collecting apparatuses, the air flow is abruptly decreased at the initial driving of the vacuum cleaner. On the contrary, the cyclone dust collecting apparatus 100 according to the present embodiments maintains almost uniform air flow without remarkable decrease.

Although not illustrated, the above-described cyclone dust collecting apparatus 100 can be adopted by an upright-type vacuum cleaner as well.

The cyclone dust collecting apparatus 100 according to an embodiment of the present invention has the advantages as follows.

First of all, by curving the inflow guide pipe 230 that connects the air inlet 210 and the cyclone unit 220 as much as possible and smoothly connecting the inflow guide pipe 230 with the chamber outer wall 221, the air passed through the air inlet 210 and the inflow guide pipe 230 can be guided to the cyclone unit 220 without losing as much pressure as in the other general cyclone dust collecting apparatuses. As a result, when the air guided into the cyclone unit 220 generates the whirling air current, decrease of the air flowcan be minimized.

Second, since the upper end 241 of the discharge guide pipe 240 is disposed at a higher position than the dust path 310 connecting the cyclone unit 220 and the dust collection unit 270, the dust separated by the cyclone unit 220 is prevented from flowing into the discharge guide pipe 240. Accordingly, suction efficiency is improved.

Third, the section area of the air passage increases from the entrance of the discharge guide pipe 240 toward the air outlet 250. Therefore, the air passed through the discharge guide pipe 240 diffusingly flows to the suction motor of the vacuum cleaner. This structure reduces loss of pressure of the air current and also retards blocking of the outlet mesh 260, thereby retarding deterioration of the air flow.

Finally, by mounting the outlet mesh 260 to the whole area of the air outlet 250 and mounting the filter assembly 500 comprising a plurality of filters, even fine dust that is not separated in the cyclone unit 220 can be caught. Thus, dust collection efficiency can be improved.

While the invention has been shown and described with reference to certain embodiments thereof, it will be understood by those skilled in the art that various changes in form and details may be made therein without departing from the spirit and scope of the invention as defined by the appended claims.

What is claimed is:

1. A cyclone dust collecting apparatus, comprising:
a housing including an air inlet, a cyclone unit centrifugally separating dust from external air drawn in through the air inlet, a dust collection unit formed at one side of the cyclone unit to collect the separated dust, and an air outlet where the dust-separated air is discharged;
a housing cover connected to an upper part of the housing and thereby forming a dust path between the cyclone unit and the dust collection unit;
a discharge cover openably connected to a lower part of the housing; and
a filter assembly removably connected to the one side of the housing where the air outlet is formed, the filter assembly filtering off fine dust included in the air being passed through the air outlet, and
wherein the cyclone unit includes an inflow guide pipe having a substantially curved shape and guiding all of the external air drawn in through the air inlet to the cyclone unit, the air inlet being connected to the inflow guide pipe so that the external air drawn in through the air inlet directly flows to the cyclone unit.

2. The cyclone dust collecting apparatus of claim 1, wherein the cyclone unit comprises a cylindrical chamber outer wall, and wherein the inflow guide pipe has a predetermined part that is integrally formed with the cylindrical chamber outer wall.

3. The cyclone dust collecting apparatus of claim 2, wherein the dust path has an entrance that extends in a direction of the inflow guide pipe so as to be partly overlapped with the inflow guide pipe.

4. The cyclone dust collecting apparatus of claim 1, wherein the housing further comprises a discharge guide pipe that guides the dust-separated air toward the air outlet, and wherein the discharge guide pipe has an upper end that is disposed at a higher position than the dust path to prevent the separated dust from flowing into the discharge guide pipe.

5. The cyclone dust collecting apparatus of claim 4, wherein the housing further comprises a noise reducing rib mounted in the discharge guide pipe to reduce noise generated by the air passing through the discharge guide pipe by contacting with the air.

6. The cyclone dust collecting apparatus of claim 4, wherein the housing cover further comprises a discharge guide cap protruded at a position corresponding to the upper end of the discharge guide pipe in a hemisphere form to guide the dust-separated air toward the discharge guide pipe.

7. The cyclone dust collecting apparatus of claim 4, wherein all of the air passed through the discharge guide pipe moves to the air outlet.

8. The cyclone dust collecting apparatus of claim 7, wherein the discharge guide pipe has a discharge port, and wherein the housing increases in sectional area from the discharge port toward the air outlet.

9. The cyclone dust collecting apparatus of claim 8, wherein the air outlet is equipped with an outlet mesh.

10. The cyclone dust collecting apparatus of claim 9, wherein the outlet mesh is removable.

11. The cyclone dust collecting apparatus of claim 1, wherein the filter assembly comprises a first filter made of porous mesh, a second filter made of sponge comprising smaller pores than the first filter, and a third filter comprising smaller pores than the second filter, the first, second, and third filters being mounted such that the air discharged from the air outlet sequentially passes through the first to the third filters.

12. The cyclone dust collecting apparatus of claim 1, wherein the cyclone unit and the dust collection unit are arranged in parallel in the housing.

13. A cyclone dust collecting apparatus, comprising:
a housing having a front portion and a rear portion;
an air inlet in the housing at a center of the front portion where external air is drawn in;
a cyclone unit in the housing at a first side of the air inlet to centrifugally separate dust from the external air;
a dust collection unit in the housing at a second side of the air inlet to collect the separated dust;
an air outlet in the rear portion where dust-separated air is discharged;
a housing cover at an upper part of the housing to form a dust path between the cyclone unit and the dust collection unit; and
an inflow guide pipe having a substantially curved shape and being connected to the air inlet so that all of the external air directly flows to the cyclone unit.

14. The cyclone dust collecting apparatus of claim 13, further comprising a discharge cover openably connected to a lower part of the housing.

15. The cyclone dust collecting apparatus of claim 13, further comprising a filter assembly removably connected to the air outlet, wherein the filter assembly filters off fine dust included in the air being passed through the air outlet.

16. The cyclone dust collecting apparatus of claim 13, wherein the housing further comprises a discharge guide pipe that guides the dust-separated air toward the air outlet.

17. The cyclone dust collecting apparatus of claim 16, wherein the discharge guide pipe has an upper end that is disposed at a higher position than the dust path to prevent the separated dust from flowing into the discharge guide pipe.

18. The cyclone dust collecting apparatus of claim 16, wherein the discharge guide pipe has a discharge port, and wherein the housing increases in sectional area from the discharge port toward the air outlet.

19. The cyclone dust collecting apparatus of claim 13, wherein the air outlet is equipped with an outlet mesh.

20. The cyclone dust collecting apparatus of claim 13, wherein the cyclone unit and the dust collection unit are arranged in parallel in the housing.
